(19) United States
(12) Patent Application Publication
(10) Pub. No.: US 2019/0089817 A1
(43) Pub. Date: Mar. 21, 2019

(54) System and Method of Utilizing Multiple Wireless Protocols

(71) Applicant: Dell Products L.P., Round Rock, TX (US)

(72) Inventor: Sinem Gulbay, Austin, TX (US)

(21) Appl. No.: 15/707,264

(22) Filed: Sep. 18, 2017

(51) Int. Cl. H04L 29/06; G02B 27/01; H04W 4/02

(52) U.S. Cl. CPC H04L 69/03; G02B 2027/0185; H04W 4/026; G02B 27/01

(57) ABSTRACT

In one or more embodiments, one or more systems, methods, and/or processes may determine a first position of a wearable device, configured to be worn by a user, via a first wireless protocol; may determine, based at least on the first position, that the wearable device is within a threshold distance of a boundary; and in response to determining, based at least on the first position, that the wearable device is within the threshold distance of the boundary, may determine a second position of the wearable device via a second wireless protocol, different from the first wireless protocol, that is operable to provide greater measurement precision than the first wireless protocol. For example, the wearable device may include a head mounted display. In one or more embodiments, the first wireless protocol may include a Wi-Fi protocol, and the second protocol may include a WiGig protocol.

### BACKGROUND

### Field of the Disclosure

This disclosure relates generally to information handling systems and more particularly to utilizing wireless protocols in determining one or more positions.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY

In one or more embodiments, one or more systems, methods, and/or processes may determine a first position of a wearable device, configured to be worn by a user, via a first wireless protocol and may determine, based at least on the first position, that the wearable device is within a threshold distance of a boundary. For example, in response to determining, based at least on the first position, that the wearable device is within the threshold distance of the boundary, the one or more systems, methods, and/or processes may determine a second position of the wearable device via a second wireless protocol, different from the first wireless protocol, that is operable to provide greater measurement precision than the first wireless protocol. For instance, determining the second position of the wearable device via the second wireless protocol may include determining an angular position. In one or more embodiments, the wearable device may include a head mounted display.

In one or more embodiments, the one or more systems, methods, and/or processes may determine, based at least on the second position, that the wearable device is within the threshold distance of the boundary. In one example, in response to determining, based at least on the second position, that the wearable device is within the threshold distance of the boundary, the one or more systems, methods, and/or processes may provide at least one virtual reality image to the head mounted display to direct one or more movements of the user away from the boundary. In another example, in response to determining, based at least on the second position, that the wearable device is within the threshold distance of the boundary, the one or more systems, methods, and/or processes may provide an alert to the wearable device. For instance, the wearable device may provide the alert and/or information based on the alert to the user.

In one or more embodiments, the one or more systems, methods, and/or processes may determine, based at least on the second position, that the wearable device is not within the threshold distance of the boundary, and may, in response to determining, based at least on the second position, that the wearable device is not within the threshold distance of the boundary, cease utilization of the second wireless protocol to determine one or more positions of the wearable device. In one or more embodiments, the first wireless protocol may include a Wi-Fi protocol, and the second protocol may include a WiGig protocol.

### BRIEF DESCRIPTION OF THE DRAWINGS

For a more complete understanding of the present disclosure and its features/advantages, reference is now made to the following description, taken in conjunction with the accompanying drawings, which are not drawn to scale, and in which:

FIG. 1 illustrates an example of an information handling system, according to one or more embodiments;

FIGS. 2A-2C illustrate examples of a virtual reality device utilized in an activity area, according to one or more embodiments;

FIG. 2D illustrates an example of multiple virtual reality devices utilized in an activity area, according to one or more embodiments;

FIG. 2E illustrates an example of multiple wireless protocols utilized by multiple virtual reality devices, according to one or more embodiments;

FIG. 2F illustrates another example of multiple wireless protocols utilized by multiple virtual reality devices, according to one or more embodiments;

FIGS. 3A-3C illustrate a virtual reality device, according to one or more embodiments;

FIG. 4 illustrates a method of operating an information handling system, according to one or more embodiments;

FIG. 5 illustrates a method of operating a virtual reality device, according to one or more embodiments; and

FIG. 6 illustrates a method of operating a system that utilizes a wearable device is illustrated, according to one or more embodiments.

### DETAILED DESCRIPTION

In the following description, details are set forth by way of example to facilitate discussion of the disclosed subject matter. It should be apparent to a person of ordinary skill in the field, however, that the disclosed embodiments are exemplary and not exhaustive of all possible embodiments.

As used herein, a reference numeral followed by a letter refers to a specific instance of an element and the numeral only form of the reference numeral refers to the collective element. Thus, for example, device ‘12A’ refers to an instance of a device class, which may be referred to collectively as devices ‘12’ and any one of which may be referred to generically as a device ‘12’.

In one or more embodiments, one or more systems, methods, and/or processes may provide range of mobility in one or more virtual reality (VR) environments. In one example, range of mobility in the one or more VR environments may be provided and/or improved via wireless communications. In another example, wireless communications may provide and/or improve one or more safety considerations. In one or more embodiments, the one or more systems, methods, and/or processes may determine if a user may travel outside a range of wireless communications. For example, determining if the user may travel outside the range of wireless communications may include determining if the user is approaching a boundary of wireless communications. In one or more embodiments, the one or more systems, methods, and/or processes may determine if a first user is within a threshold distance of a second user. For example, determining if the first user is within the threshold distance of the second user may provide and/or improve one or more safety considerations. For instance, determining if the first user is within the threshold distance of the second user may prevent, avert, and/or mitigate a collision between the firsts user and the second user.

In one or more embodiments, the one or more systems, methods, and/or processes may periodically or continuously determine one or more distances. For example, the one or more distances may include one or more of a distance between an information handling system and a device (e.g., a VR device) of a user, a distance between a first device (e.g., a first VR device) of a first user and a second device (e.g., a second VR device) of a second user, and a distance between a device (e.g., a VR device) of a user and a boundary, among others.

In one or more embodiments, a wireless VR device, such as a wireless head mounted display (HMD), may be coupled to an information handling system, and a connectivity region between information handling system and the wireless VR device may be characterized by mapping an area where wireless connectivity may be kept at a minimum modulation and coding scheme (MCS) level for a wireless data path that may permit wireless connectivity. For example, the wireless data path may include an Institute of Electrical and Electronics Engineers (IEEE) 802.11ad wireless data path. In one or more embodiments, the information handling system may determine an activity area. In one example, determining the activity area may be based at least on the connectivity region. In another example, determining the activity area may be based at least on one or more physical constraints. For instance, the one or more physical constraints may include a physical obstruction, a physical wall, a physical pedestal, a physical table, a physical couch, a physical desk, a physical chair, and a physical piece of furniture, among others.

In one or more embodiments, the information handling system may adjust, change, and/or augment one or more images and/or one or more videos displayed to the user via the VR device (e.g., a wireless HMD) based at least on the activity area. In one example, the information handling system may adjust, change, and/or augment one or more images and/or one or more videos displayed to the user via the VR device based at least on the one or more physical constraints of the activity area. In another example, the information handling system may adjust, change, and/or augment one or more images and/or one or more videos displayed to the user via the VR device based at least on the connectivity region.

In one or more embodiments, a VR device may enter the activity area or become activated within the activity area, and the information handling system may initiate a session between the information handling system and the VR device. For example, the information handling system may initiate periodic or continuous tracking of one or more positions of the VR device. In one instance, the periodic or continuous tracking of the one or more positions of the VR device may be with respect to the information handling system. In another instance, the periodic or continuous tracking of the one or more positions of the VR device may be with respect to one or more antennas associated with the information handling system. In one or more embodiments, the periodic or continuous tracking of the one or more positions of the VR device may include utilizing IEEE 802.11mc. For instance, the periodic or continuous tracking of the one or more positions of the VR device may include utilizing IEEE 802.11mc Wi-Fi location technology.

In one or more embodiments, the information handling system may determine that a VR device is proximate to a boundary of the activity area. For example, the information handling system may utilize another wireless protocol that may provide greater precision in determining the one or more positions of the VR device, in response to determining that the VR device is proximate to the boundary of the activity area. In one instance, the other wireless protocol that may provide greater precision in determining the one or more positions of the VR device may include WiGig (e.g., IEEE 802.11ad), among others. In a second instance, the other wireless protocol that may provide greater precision in determining the one or more positions of the VR device may consume more power from the information handling system and/or the VR device, compared to a power consumption of the wireless protocol. In another instance, the other wireless protocol may provide greater precision in determining the one or more positions of the VR device and/or may determine an angular position and/or a range (e.g., a distance from an antenna of the information handling system to an antenna of the VR device). In one or more embodiments, the other wireless protocol may be utilized in addition to the wireless protocol. For example, WiGig (e.g., IEEE 802.11ad) may be utilized in addition to IEEE 802.11mc and/or Wi-Fi.

In one or more embodiments, the information handling system may determine that a VR device is predicted to be proximate to a boundary of the activity area. For example, the information handling system may utilize another wireless protocol that may provide greater precision in determining the one or more positions of the VR device, in response to determining that the VR device is predicted to be proximate to the boundary of the activity area. For instance, determining that the VR device is predicted to be proximate to the boundary of the activity area may include determining a speed and/or a direction of movement of the VR device. In one or more embodiments, the information handling system may provide one or more notifications and/or one or more images (e.g., graphics data) to encourage one or more users of respective one or more VR devices to remain in the activity area and/or to avoid collisions between or among users. For example, the information handling system may provide the one or more notifications and/or the one or more images based at least on range information and/or orientation information. For instance, the range information may include and/or be based at least on one or more positions of one or more VR devices.

In one or more embodiments, the information handling system may provide instructions to one or more VR devices to utilize a low power consumption mode, when the information handling system determines that the one or more VR devices are not proximate to a boundary of the activity area and/or are not proximate to another VR device. For example, the low power consumption mode may include Wi-Fi location technology. In one or more embodiments, one or more systems, methods, and/or processes may utilize one or more peer-to-peer wireless ranging measurements. In one example, the one or more peer-to-peer wireless ranging measurements may utilize IEEE 802.11mc to determine and/or track positions of VR devices with respect to each other and the information handling system. In another example, the one or more peer-to-peer wireless ranging measurements may utilize IEEE 802.11mc to determine and/or track positions of VR devices with respect to each other, and the VR devices may provide ranging and/or position information to the information handling system.

In one or more embodiments, one or more VR environments may be utilized in one or more of gaming applications, data visualization, education, training, simulation, communication, content creation, and entertainment, among others. For example, the one or more systems, methods, and/or processes described herein may be utilized in and/or with mobile wireless consumer and/or commercial VR devices (e.g., VR head mounted displays, etc).

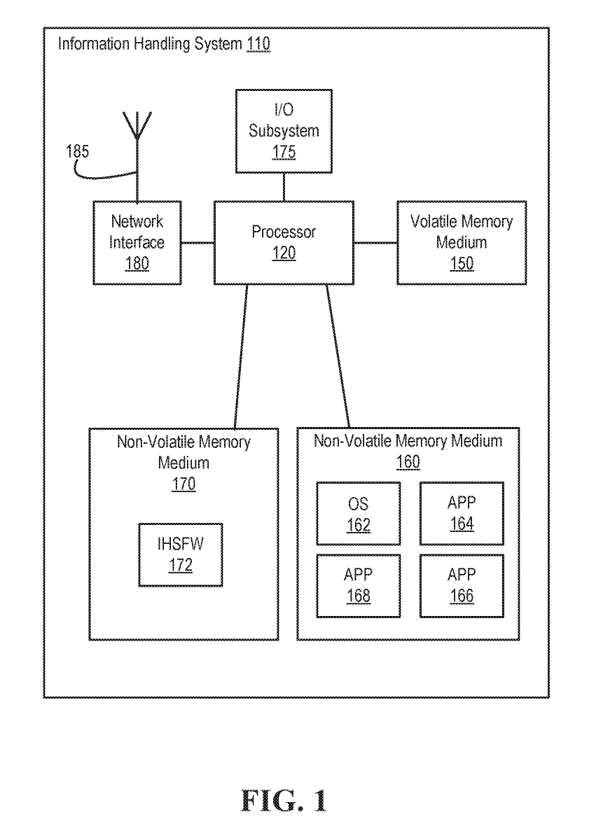

Turning now to FIG. 1, an exemplary information handling system is illustrated, according to one or more embodiments. An information handling system (IHS) 110 may include a hardware resource or an aggregate of hardware resources operable to compute, classify, process, transmit, receive, retrieve, originate, switch, store, display, manifest, detect, record, reproduce, handle, and/or utilize various forms of information, intelligence, or data for business, scientific, control, entertainment, or other purposes, according to one or more embodiments. For example, IHS 110 may be a personal computer, a desktop computer system, a laptop computer system, a server computer system, a mobile device, a personal digital assistant (PDA), a wireless access point, a consumer electronic device, an electronic music player, an electronic camera, an electronic video player, a network storage device, or another suitable device and may vary in size, shape, performance, functionality, and price. In one or more embodiments, components of IHS 110 may include one or more storage devices, one or more communications ports for communicating with external devices as well as various input and output (I/O) devices, such as a keyboard, a mouse, and a video display, among others. In one or more embodiments, IHS 110 may include one or more buses operable to transmit communication between or among two or more hardware components. In one example, a bus of IHS 110 may include one or more of a memory bus, a peripheral bus, and a local bus, among others. In another example, a bus of IHS 110 may include one or more of a Micro Channel Architecture (MCA) bus, an Industry Standard Architecture (ISA) bus, an Enhanced ISA (EISA) bus, a Peripheral Component Interconnect (PCI) bus, HyperTransport (HT) bus, an inter-integrated circuit (I²C) bus, a serial peripheral interface (SPI) bus, a low pin count (LPC) bus, an enhanced serial peripheral interface (eSPI) bus, a universal serial bus (USB), a system management bus (SMBus), and a Video Electronics Standards Association (VESA) local bus, among others.

In one or more embodiments, IHS 110 may include firmware that controls and/or communicates with one or more hard drives, network circuitry, one or more memory devices, one or more I/O devices, and/or one or more other peripheral devices. For example, firmware may include software embedded in an IHS component utilized to perform tasks. In one or more embodiments, firmware may be stored in non-volatile memory, such as storage that does not lose stored data upon loss of power. In one example, firmware associated with an IHS component may be stored in non-volatile memory that is accessible to one or more IHS components. In another example, firmware associated with an IHS component may be stored in non-volatile memory that may be dedicated to and includes part of that component. For instance, an embedded controller may include firmware that may be stored via non-volatile memory that may be dedicated to and includes part of the embedded controller.

As shown, IHS 110 may include a processor 120, a volatile memory medium 150, non-volatile memory media 160 and 170, an I/O subsystem 175, and a network interface 180. As illustrated, volatile memory medium 150, non-volatile memory media 160 and 170, I/O subsystem 175, and network interface 180 may be communicatively coupled to processor 120.

In one or more embodiments, one or more of volatile memory medium 150, non-volatile memory media 160 and 170, I/O subsystem 175, and network interface 180 may be communicatively coupled to processor 120 via one or more buses, one or more switches, and/or one or more root complexes, among others. In one example, one or more of volatile memory medium 150, non-volatile memory media 160 and 170, I/O subsystem 175, and network interface 180 may be communicatively coupled to processor 120 via one or more PCI-Express (PCIe) root complexes. In another example, one or more of an I/O subsystem 175 and a network interface 180 may be communicatively coupled to processor 120 via one or more PCIe switches.

In one or more embodiments, the term “memory medium” may mean a “storage device”, a “memory”, a “memory device”, a “tangible computer readable storage medium”, and/or a “computer-readable medium”. For example, computer-readable media may include, without limitation, storage media such as a direct access storage device (e.g., a hard disk drive, a floppy disk, etc.), a sequential access storage device (e.g., a tape disk drive), a compact disk (CD), a CD-ROM, a digital versatile disc (DVD), a random access memory (RAM), a read-only memory (ROM), a one-time programmable (OTP) memory, an electrically erasable programmable read-only memory (EEPROM), and/or a flash memory, a solid state drive (SSD), or any combination of the foregoing, among others.

In one or more embodiments, one or more protocols may be utilized in transferring data to and/or from a memory medium. For example, the one or more protocols may include one or more of small computer system interface (SCSI), Serial Attached SCSI (SAS) or another transport that operates with the SCSI protocol, advanced technology attachment (ATA), serial ATA (SATA), a USB interface, an IEEE 1394 interface, a Thunderbolt interface, an advanced technology attachment packet interface (ATAPI), serial storage architecture (SSA), integrated drive electronics (IDE), or any combination thereof, among others.

Volatile memory medium 150 may include volatile storage such as, for example, RAM, DRAM (dynamic RAM), EDO RAM (extended data out RAM), SRAM (static RAM), etc. One or more of non-volatile memory media 160 and 170 may include nonvolatile storage such as, for example, a read only memory (ROM), a programmable ROM (PROM), an erasable PROM (EPROM), an electrically erasable PROM, NVRAM (non-volatile RAM), ferroelectric RAM (FRAM), a magnetic medium (e.g., a hard drive, a floppy disk, a magnetic tape, etc.), optical storage (e.g., a CD, a DVD, a BLU-RAY disc, etc.), flash memory, a SSD, etc. In one or more embodiments, a memory medium can include one or more volatile storages and/or one or more nonvolatile storages.

In one or more embodiments, network interface 180 may be utilized in communicating with one or more networks and/or one or more other information handling systems. In one example, network interface 180 may enable IHS 110 to communicate via a network utilizing a suitable transmission protocol and/or standard. In a second example, network interface 180 may be coupled to a wired network. In a third example, network interface 180 may be coupled to an optical network. In fourth example, network interface 180 may be coupled to a wireless network. For instance, the wireless network may include one or more of a Wi-Fi network, a WiGig network, a wireless Ethernet network, a Bluetooth network, and a 6 LoPAN network, among others. In another example, network interface 180 may be coupled to one or more wireless devices. In one instance, network interface 180 may be coupled to the one or more a wireless devices via Wi-Fi, WiGig, wireless Ethernet, Bluetooth, and 6 LoPAN network, among others. In another instance, the one or more wireless device may include one or more of a wearable device (e.g., a device configured to be worn by a user), a head mounted display (HIVID), a personal computer, a desktop computer system, a laptop computer system, a server computer system, a mobile device, a PDA, a wireless access point, a consumer electronic device, an electronic music player, an electronic camera, an electronic video player, and a network storage device, among others. In one or more embodiments, network interface 180 may be configured to communicate information via one or more wireless protocols. For example, the one or more wireless protocols may include one or more of IEEE 802.11a, IEEE 802.11ac, IEEE 802.11ad, IEEE 802.11ah, IEEE 802.11aj, IEEE 802.11ax, IEEE 802.11az, IEEE 802.11b, IEEE 802.11g, IEEE 802.11mc, IEEE 802.11n, IEEE 802.15, and IEEE 802.15.4, among others.

In one or more embodiments, network interface 180 may be communicatively coupled via a network to a network storage resource. For example, the network may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, an Internet or another appropriate architecture or system that facilitates the communication of signals, data and/or messages (generally referred to as data). For instance, the network may transmit data utilizing a desired storage and/or communication protocol, including one or more of Fibre Channel, Frame Relay, Asynchronous Transfer Mode (ATM), Internet protocol (IP), other packet-based protocol, Internet SCSI (iSCSI), or any combination thereof, among others.

As illustrated, IHS 110 may include an antenna 185, and antenna 185 may be coupled to network interface 180. In one or more embodiments, antenna 185 may be external to IHS 110, though not specifically shown. In one or more embodiments, antenna 185 may include one or more antennas. In one example, antenna 185 may include an antenna array. In a second example, antenna 185 may include a first antenna that may be utilized in transmitting radio waves. In another example, antenna 185 may include a second antenna that may be utilized in receiving radio waves. In one or more embodiments, antenna 185 may convert electric power into radio waves, which may be utilized in transmitting wireless communications. In one or more embodiments, antenna 185 may convert radio waves into electric power, which may be utilized in receiving wireless communications.

In one or more embodiments, processor 120 may execute processor instructions in implementing one or more systems, flowcharts, methods, and/or processes described herein. In one example, processor 120 may execute processor instructions from one or more of memory media 150-170 in implementing one or more systems, flowcharts, methods, and/or processes described herein. In another example, processor 120 may execute processor instructions via network interface 180 in implementing one or more systems, flowcharts, methods, and/or processes described herein.

In one or more embodiments, processor 120 may include one or more of a system, a device, and an apparatus operable to interpret and/or execute program instructions and/or process data, among others, and may include one or more of a microprocessor, a microcontroller, a digital signal processor (DSP), an application specific integrated circuit (ASIC), and another digital or analog circuitry configured to interpret and/or execute program instructions and/or process data, among others. In one example, processor 120 may interpret and/or execute program instructions and/or process data stored locally (e.g., via memory media 150-170 and/or another component of IHS 110). In another example, processor 120 may interpret and/or execute program instructions and/or process data stored remotely (e.g., via a network storage resource).

In one or more embodiments, I/O subsystem 175 may represent a variety of communication interfaces, graphics interfaces, video interfaces, user input interfaces, and/or peripheral interfaces, among others. For example, I/O subsystem 175 may include one or more of a touch panel and a display adapter, among others. For instance, a touch panel may include circuitry that enables touch functionality in conjunction with a display that is driven by a display adapter.

As shown, non-volatile memory medium 160 may include an operating system (OS) 162, and applications (APPs) 164-168. In one or more embodiments, one or more of OS 162 and APPs 164-168 may include processor instructions executable by processor 120. In one example, processor 120 may execute processor instructions of one or more of OS 162 and APPs 164-168 via non-volatile memory medium 160. In another example, one or more portions of the processor instructions of the one or more of OS 162 and APPs 164-168 may be transferred to volatile memory medium 150, and processor 120 may execute the one or more portions of the processor instructions of the one or more of OS 162 and APPs 164-168 via volatile memory medium 150.

As illustrated, non-volatile memory medium 170 may include information handling system firmware (IHSFW) 172. In one or more embodiments, IHSFW 172 may include processor instructions executable by processor 120. For example, IHSFW 172 may include one or more structures and/or functionalities of one or more of a basic input/output system (BIOS), an Extensible Firmware Interface (EFI), a Unified Extensible Firmware Interface (UEFI), and an Advanced Configuration and Power Interface (ACPI), among others. In one instance, processor 120 may execute processor instructions of IHSFW 172 via non-volatile memory medium 170. In another instance, one or more portions of the processor instructions of IHSFW 172 may be transferred to volatile memory medium 150, and processor 120 may execute the one or more portions of the processor instructions of IHSFW 172 via volatile memory medium 150.

In one or more embodiments, processor 120 and one or more components of IHS 110 may be included in a system-on-chip (SoC). For example, the SoC may include processor 120 and a platform controller hub (not specifically illustrated).

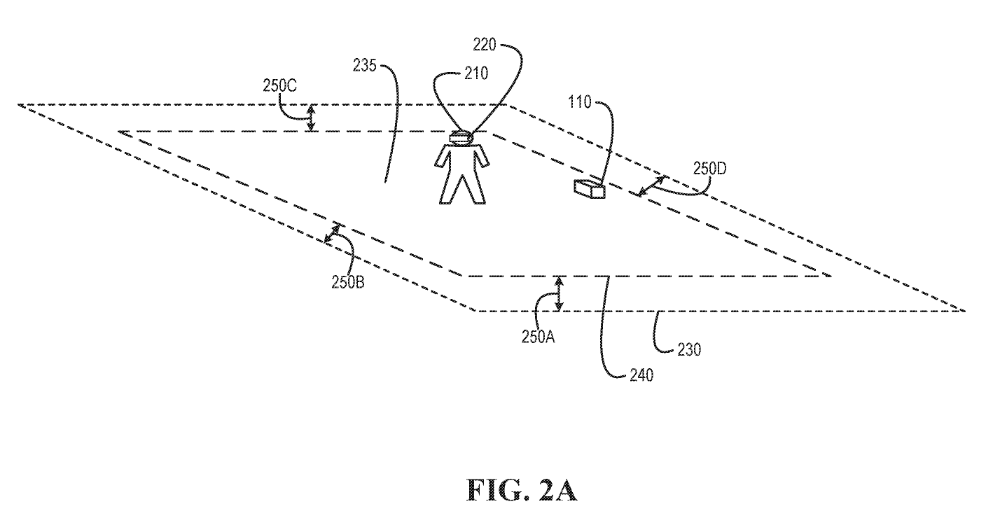

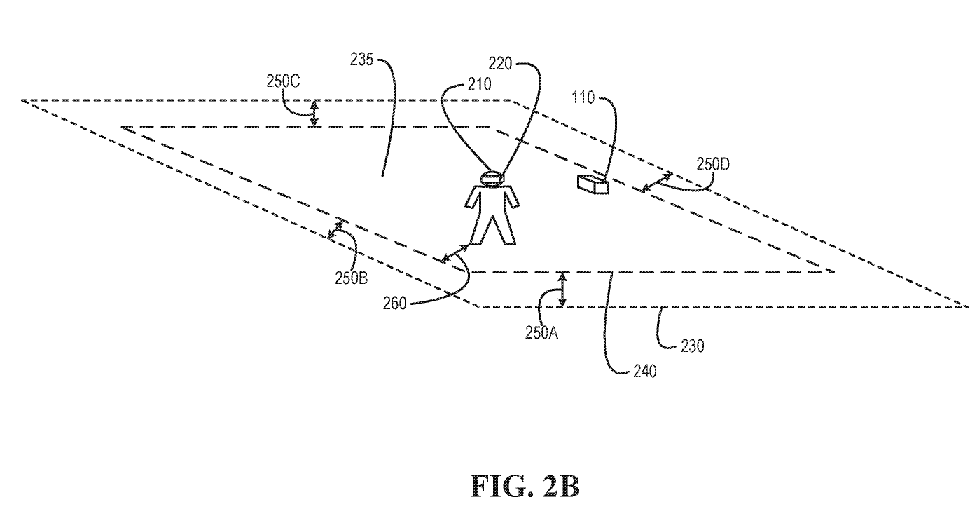

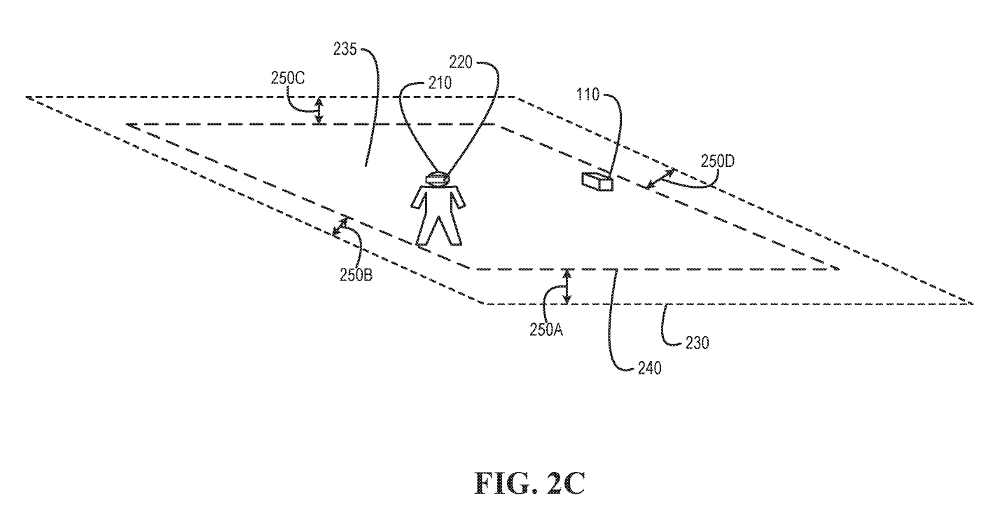

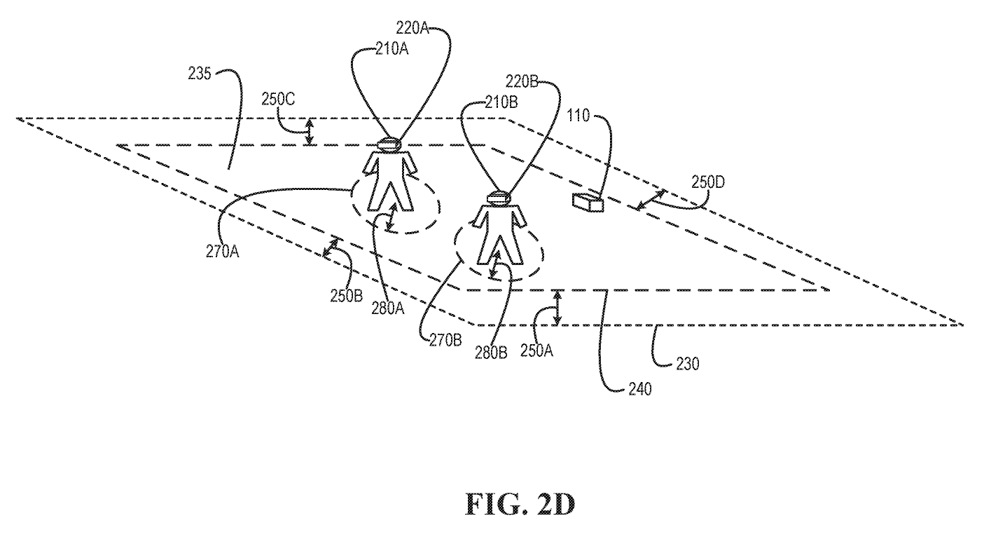

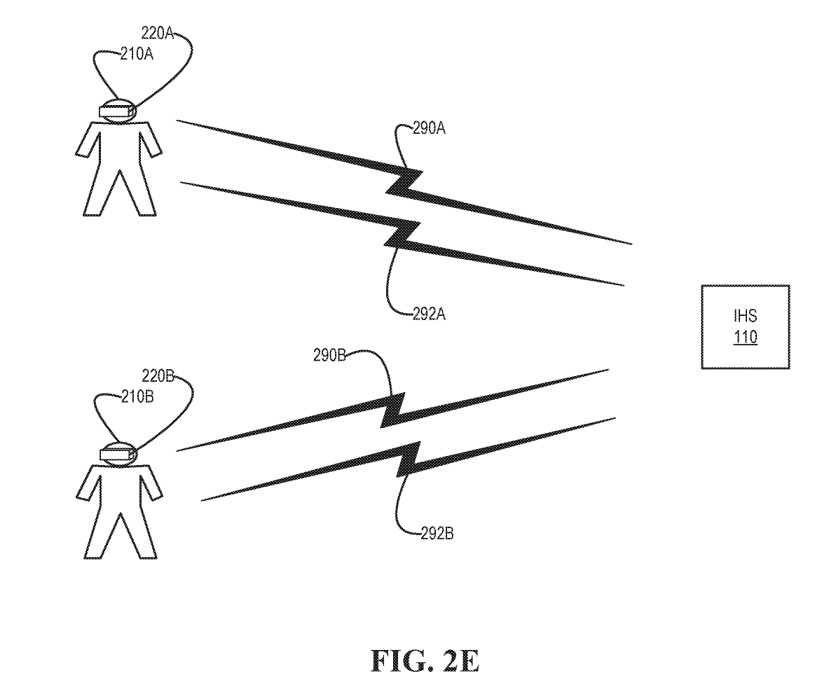

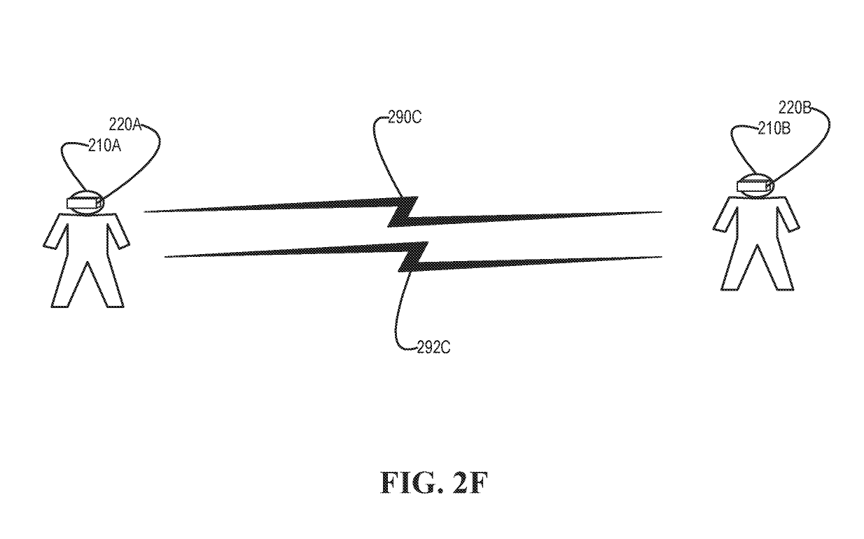

Turning now to FIGS. 2A-2C, examples of a virtual reality device utilized in an activity area are illustrated, according to one or more embodiments. With reference to FIG. 2A, a user 210 may wear a VR device 220. In one or more embodiments, VR device 220 may be or include a HIVID. As illustrated, a boundary 230 may enclose an activity area 235. In one example, boundary 230 may be associated with a limit of wireless communications between VR device 220 and IHS 110. In another example, boundary 230 may be associated with one or more safety considerations. For instance, the one or more safety considerations may include one or more the one or more physical considerations, which may include one or more of a physical obstruction, a physical wall, a physical pedestal, a physical table, a physical couch, a physical desk, a physical chair, and a physical piece of furniture, among others. As shown, an interior boundary 240 may be associated with the activity area. As illustrated, interior boundary 240 may be at distances 250A-250D from boundary 230.

With reference to FIG. 2B, VR device 220 may be at a distance 260 from interior boundary 240. In one example, VR device 220 may determine distance 260 from interior boundary 240. In another example, IHS 220 may determine distance 260 from interior boundary 240. As illustrated, VR device 220 may be at distance 260 plus distance 250B from boundary 230. In one instance, a threshold distance from boundary 230 may be distance 260 plus distance 250B. In another instance, a threshold distance from boundary 230 may be distance 250B. With reference to FIG. 2C, VR device 220 may be at distance 250B from boundary 230. In one example, VR device 220 may determine distance 250B from boundary 230. In another example, IHS 220 may determine distance 250B from boundary 230.

Turning now to FIG. 2D, an example of multiple virtual reality devices utilized in an activity area is illustrated, according to one or more embodiments. As shown, users 210A and 210B may wear respective VR devices 220A and 220B. In one or more embodiments, VR devices 220A and 220B may be or include respective head mounted displays (HMDs). As illustrated, a boundary 270A may surround VR device 220A, and a boundary 270B may surround VR device 220B. For example, a distance 280A may be a radius of boundary 270A, and a distance 280B may be a radius of boundary 270B. In one instance, distances 280A and 280B may be equal. In another instance, distances 280A and 280B may not be equal.

Turning now to FIG. 2E, an example of multiple wireless protocols utilized by multiple virtual reality devices is illustrated, according to one or more embodiments. As shown, IHS 110 and VR device 220A may communicate via wireless signals 290A and via wireless signals 292A. In one or more embodiments, a first wireless path may include wireless signals 290A, and a second wireless path may include wireless signals 292A. As illustrated, IHS 110 and VR device 220B may communicate via wireless signals 290B and via wireless signals 292B. In one or more embodiments, a first wireless path may include wireless signals 290B, and a second wireless path may include wireless signals 292B.

In one or more embodiments, wireless signals 290 may utilize a first wireless protocol, and wireless signals 292 may utilize a second wireless protocol, different from the first wireless protocol. In one example, wireless signals 290 (e.g., a first wireless path) may utilize a Wi-Fi protocol. In one instance, the Wi-Fi protocol may utilize one or more of IEEE 802.11a, IEEE 802.11ac, IEEE 802.11ah, IEEE 802.11ax, IEEE 802.11az, IEEE 802.11b, IEEE 802.11g, IEEE 802.11mc, and IEEE 802.11n, among others. In another instance, the Wi-Fi protocol may utilize one or more of a 2.4 GHz ISM (Industrial, Scientific, and Medical) band and a 5 GHz ISM band, among others. In another example, wireless signals 292 (e.g., a second wireless path) may utilize a WiGig protocol. In one instance, the WiGig protocol may utilize one or more of IEEE 802.11ad and IEEE 802.11aj, among others. In another instance, the WiGig protocol may utilize a 60 GHz ISM band, among others. In one or more embodiments, one or more of the first wireless protocol and the second wireless protocol may be utilized in determining one or more positions of VR device 220 and/or may be utilized in ranging of one or more VR devices 220. In one or more embodiments, the second wireless protocol may be operable to provide greater measurement precision than the first wireless protocol.

In one or more embodiments, utilizing the second wireless protocol may consume more power than utilizing the first wireless protocol. In one example, the first wireless protocol may be utilized, and when greater measurement precision than the first wireless protocol may provide is needed, required, and/or desired, the second wireless protocol may be utilized to provide greater measurement precision than the first wireless protocol. In another example, when greater measurement precision than the first wireless protocol is no longer needed, required, and/or desired, the first wireless protocol may be utilized. For instance, utilizing the first wireless protocol may conserve power when greater measurement precision than the first wireless protocol is no longer needed, required, and/or desired. In one or more embodiments, the second wireless protocol may be utilized in providing one or more of image data and video data to VR device 220. For example, the second wireless protocol may be utilized, in addition to providing one or more of image data and video data to VR device 220, to provide greater measurement precision than the first wireless protocol, when utilized in determining one or more positions of VR device 220. In one or more embodiments, the second wireless protocol may be operable to produce and/or may be utilizable to determine one or more angular positions of VR device 220.

Turning now to FIG. 2F, another example of multiple wireless protocols utilized by multiple virtual reality devices is illustrated, according to one or more embodiments. As shown, VR devices 220A and 220B may communicate via wireless signals 290C and via wireless signals 292C. In one or more embodiments, wireless signals 290 may utilize a first wireless protocol, and wireless signals 292 may utilize a second wireless protocol, different from the first wireless protocol, as described herein. In one or more embodiments, VR devices 220A and 220B may utilize one or more peer-to-peer wireless ranging measurements. In one example, the one or more peer-to-peer wireless ranging measurements may utilize IEEE 802.11mc to determine and/or track positions of VR devices 220A and 220B with respect to each other and/or IHS 110. In another example, the one or more peer-to-peer wireless ranging measurements may utilize IEEE 802.11mc to determine and/or track positions of VR devices 220A and 220B with respect to each other, and VR devices 220A and 220B may provide ranging and/or position information to IHS 110.

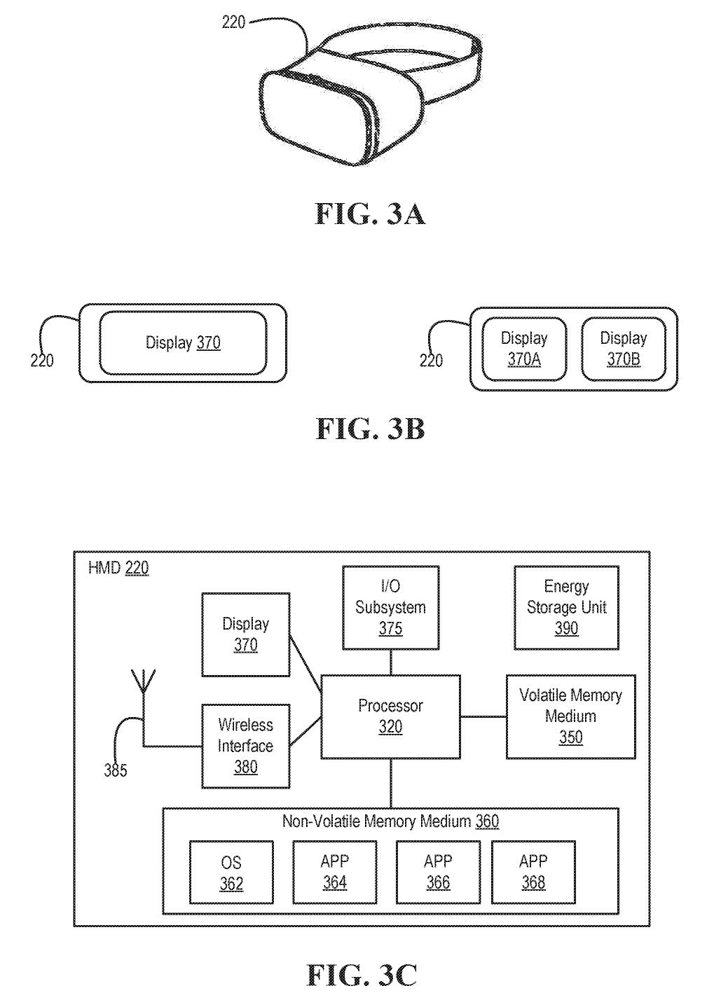

Turning now to FIGS. 3A-3C, a virtual reality device is illustrated, according to one or more embodiments. As illustrated in FIG. 3A, VR device 220 may be a wearable device. In one or more embodiments, VR device 220 may be or include a HIVID. As shown in FIG. 3B, VR device 220 may include a single display 370 or may include multiple displays 370A and 370B. Referring to display 370 may refer to a single display or one or more of multiple displays 370A and 370B, according to one or more embodiments. For example, one or more images and/or one or more videos may be provided to user 210 via display 370.

With reference to FIG. 3C, further details of VR device 220 are provided, according to one or more embodiments. As shown, VR device 220 may include a processor 320, a volatile memory medium 350, a non-volatile memory medium 360, display 370, an I/O subsystem 375, and a wireless interface 380. As illustrated, volatile memory medium 350, non-volatile memory medium 360, display 370, and I/O subsystem 375 may be communicatively coupled to processor 320. In one or more embodiments, one or more of volatile memory medium 350, non-volatile memory media 360 and 370, I/O subsystem 375, and network interface 380 may be communicatively coupled to processor 320 via one or more buses, one or more switches, and/or one or more root complexes, described herein, among others. In one or more embodiments, volatile memory medium 350 may include one or more structures and/or functionalities as those described with reference to volatile memory medium 150, and non-volatile memory medium 360 may include one or more structures and/or functionalities as those described with reference to non-volatile memory medium 160.

In one or more embodiments, wireless interface 380 may be utilized in wirelessly communicating with one or more networks, one or more other VR devices 220, and/or one or more information handling systems. In one example, wireless interface 380 may enable VR device 220 to wirelessly communicate via a network utilizing a suitable transmission protocol and/or standard. In a second example, wireless interface 380 may be wirelessly coupled to a wireless network. For instance, the wireless network may include one or more of a Wi-Fi network, a WiGig network, a wireless Ethernet network, a Bluetooth network, and a 6 LoPAN network, among others. In another example, wireless interface 380 may be wirelessly coupled to one or more wireless devices. In one instance, wireless interface 380 may be wirelessly coupled to the one or more wireless devices via Wi-Fi, WiGig, wireless Ethernet, Bluetooth, and 6 LoPAN network, among others. In another instance, the one or more wireless devices may include one or more of a wearable device (e.g., a device configured to be worn by a user), a HMD, a VR device, a personal computer, a desktop computer system, a laptop computer system, a server computer system, a mobile device, a PDA, a wireless access point, a consumer electronic device, an electronic music player, an electronic camera, an electronic video player, and a network storage device, among others. In one or more embodiments, wireless interface 380 may be configured to wirelessly communicate information via one or more wireless protocols. For example, the one or more wireless protocols may include one or more of IEEE 802.11a, IEEE 802.11ac, IEEE 802.11ad, IEEE 802.11ah, IEEE 802.11aj, IEEE 802.11ax, IEEE 802.11az, IEEE 802.11b, IEEE 802.11g, IEEE 802.11mc, IEEE 802.11n, IEEE 802.15, and IEEE 802.15.4, among others.

As illustrated, VR device 220 may include an antenna 385, and antenna 385 may be coupled to wireless interface 380. In one or more embodiments, antenna 385 may be external to VR device 220, though not specifically shown. In one or more embodiments, antenna 385 may include one or more antennas. In one example, antenna 385 may include an antenna array. In a second example, antenna 385 may include a first antenna that may be utilized in transmitting radio waves. In another example, antenna 385 may include a second antenna that may be utilized in receiving radio waves. In one or more embodiments, antenna 385 may convert electric power into radio waves, which may be utilized in transmitting wireless communications. In one or more embodiments, antenna 385 may convert radio waves into electric power, which may be utilized in receiving wireless communications.

In one or more embodiments, processor 320 may execute processor instructions in implementing one or more systems, flowcharts, methods, and/or processes described herein. In one example, processor 320 may execute processor instructions from one or more of memory media 350 and 360 in implementing one or more systems, flowcharts, methods, and/or processes described herein. In another example, processor 320 may execute processor instructions via wireless interface 380 in implementing one or more systems, flowcharts, methods, and/or processes described herein.

In one or more embodiments, processor 320 may include one or more of a system, a device, and an apparatus operable to interpret and/or execute program instructions and/or process data, among others, and may include one or more of a microprocessor, a microcontroller, a DSP, an ASIC, and another digital or analog circuitry configured to interpret and/or execute program instructions and/or process data, among others. In one example, processor 320 may interpret and/or execute program instructions and/or process data stored locally (e.g., via memory media 350 and 360 and/or another component of VR device 220). In another example, processor 320 may interpret and/or execute program instructions and/or process data stored remotely (e.g., via a network storage resource). In one or more embodiments, I/O subsystem 375 may represent a variety of communication interfaces, graphics interfaces, video interfaces, user input interfaces, and/or peripheral interfaces, among others.

As shown, non-volatile memory medium 360 may include an OS 362, and APPs 364-368. For example, OS 362 may be or include one or more of an embedded OS, a real-time OS, and an application OS, among others. In one or more embodiments, one or more of OS 362 and APPs 364-368 may include processor instructions executable by processor 320. In one example, processor 320 may execute processor instructions of one or more of OS 362 and APPs 364-368 via non-volatile memory medium 360. In another example, one or more portions of the processor instructions of the one or more of OS 362 and APPs 364-368 may be transferred to volatile memory medium 350, and processor 320 may execute the one or more portions of the processor instructions of the one or more of OS 362 and APPs 364-368 via volatile memory medium 350.

As illustrated, VR device 220 may include an energy storage unit 390. For example, energy storage unit 390 may be or include a power supply that may supply power to one or more elements of VR device 220. In one or more embodiments, energy storage unit 390 may be or may include one or more of a rechargeable battery and a capacitor, among others. In one example, the rechargeable battery may store energy via chemical energy. In another example, the capacitor may store energy via an electric field. In one or more embodiments, energy storage unit 390 may provide power to one or more elements of VR device 220, among others.

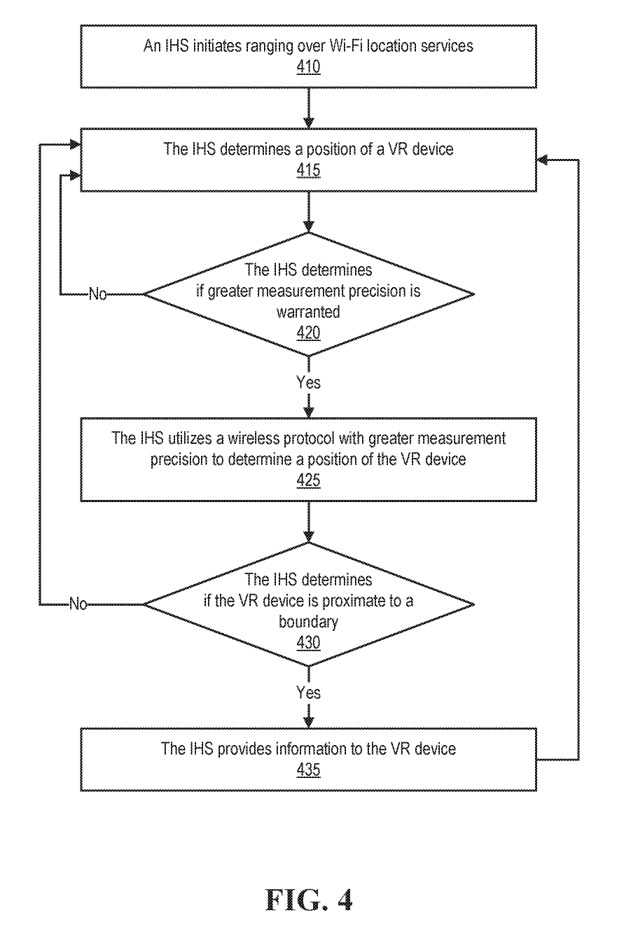

Turning now to FIG. 4, a method of operating an information handling system is illustrated, according to one or more embodiments. At 410, an information handling system may initiate ranging over Wi-Fi location services. For example, IHS 110 may initiate ranging over Wi-Fi location services. For instance, the Wi-Fi location services may include utilizing IEEE 802.11mc. At 415, the information handling system may determine a position of a VR device. For example, IHS 110 may determine a position (e.g., a location) of VR device 220. For instance, IHS 110 may utilize IEEE 802.11mc in determining the position of VR device 220. In one or more embodiments, the position of the VR device may be position relative to the information handling system. For example, IHS 110 may determine the position of VR device, relative to IHS 110, within activity area 235.

At 420, the information handling system may determine if greater measurement precision is warranted. For example, determining if greater measurement precision is warranted may include determining if the VR device is at or within a distance of a boundary. For instance, the VR device may be at or within a threshold distance of the boundary. In one or more embodiments, determining if greater measurement precision is warranted may include determining if greater measurement precision is needed, required, and/or desired. If greater measurement precision is not warranted, the method may proceed to 415, according to one or more embodiments. If greater measurement precision is warranted, the information handling system may utilize a wireless protocol with greater measurement precision to determine a position (e.g., a location) of the VR device, at 425. For example, IHS 110 may utilize WiGig (e.g., IEEE 802.11ad) to determine a position of VR device 220. In one or more embodiments, the position of the VR device may be position relative to the information handling system. In one or more embodiments, the position of VR device may include one or more of an angular position and a distance, among others.

At 430, the information handling system may determine if the VR device is proximate to a boundary. For example, IHS 110 may determine if VR device 220 is proximate to a boundary. In one instance, IHS 110 may determine if VR device 220 is proximate to interior boundary 240. In a second example, IHS 110 may determine if VR device 220 is proximate to boundary 230. In a third example, IHS 110 may determine if VR device 220A is proximate to boundary 270B. In another example, IHS 110 may determine if VR device 220B is proximate to boundary 270A. In one or more embodiments, determining if the VR device is proximate to a boundary may include determining if VR device is at or within a distance to the boundary. If the information handling system determines that the VR device is not proximate to the boundary, the method may proceed to 415, according to one or more embodiments. When the method proceed to 415, the wireless protocol with greater measurement precision may no longer be utilized, according to one or more embodiments. For example, WiGig may not longer be utilized in determining one or more positions of VR device 220.

If the VR device is proximate to the boundary, the information handling system may provide information to the VR device, at 435. For example, IHS 110 may provide information to VR device 220. In one or more embodiments, the information may include data and/or instructions that may cause VR device 220 to perform one or more of vibrating, producing one or more sounds, and displaying one or more images and/or one or more videos to user 210. For example, one or more vibrations, one or more sounds, one or more images, and/or one or more videos provided to user 210 may direct one or more movements of user 210 away from the boundary. For instance, the one or more images may include one or more VR images. In one or more embodiments, the method may proceed to 415, according to one or more embodiments. When the method proceed to 415, the wireless protocol with greater measurement precision may no longer be utilized, according to one or more embodiments. For example, WiGig may not longer be utilized in determining one or more positions of VR device 220.

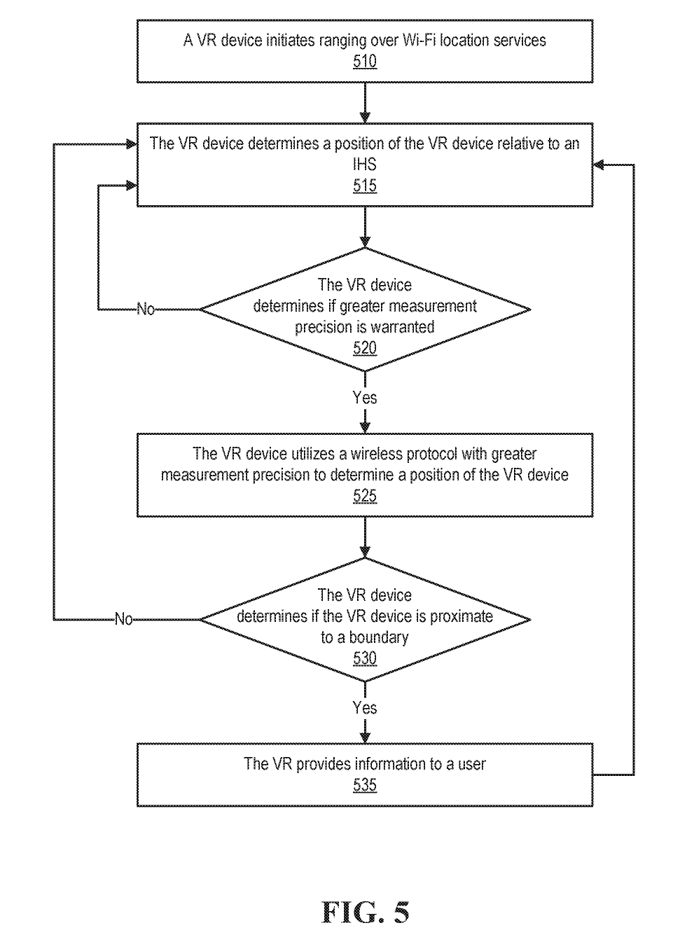

Turning now to FIG. 5, a method of operating a VR device is illustrated, according to one or more embodiments. At 510, a VR device may initiate ranging over Wi-Fi location services. For example, VR device 220 may initiate ranging over Wi-Fi location services. For instance, the Wi-Fi location services may include utilizing IEEE 802.11mc. At 515, the VR device may determine a position of relative to an information handling system. For example, VR device 220 may determine a position (e.g., a location) relative to IHS 110. For instance, VR device 220 may utilize IEEE 802.11mc in determining the position relative to IHS 110. In one or more embodiments, VR device 220 may determine the position of VR device, relative to IHS 110, within activity area 235.

At 520, the VR device may determine if greater measurement precision is warranted. For example, determining if greater measurement precision is warranted may include determining if the VR device is at or within a distance of a boundary. For instance, the VR device may be at or within a threshold distance of the boundary. In one or more embodiments, determining if greater measurement precision is warranted may include determining if greater measurement precision is needed, required, and/or desired. If greater measurement precision is not warranted, the method may proceed to 515, according to one or more embodiments. If greater measurement precision is warranted, the VR device may utilize a wireless protocol with greater measurement precision to determine a position (e.g., a location) of the VR device relative to the information handling system, at 525. For example, VR device 220 may utilize WiGig (e.g., IEEE 802.11ad) to determine a position of VR device 220 relative to IHS 110. In one or more embodiments, the position of VR device may include one or more of an angular position and a distance, among others.

At 530, the VR device may determine if the VR device is proximate to a boundary. For example, VR device 220 may determine if VR device 220 is proximate to a boundary. In one instance, VR device 220 may determine if VR device 220 is proximate to interior boundary 240. In a second example, VR device 220 may determine if VR device 220 is proximate to boundary 230. In a third example, VR device 220A may determine if VR device 220A is proximate to boundary 270B. In another example, VR device 220B may determine if VR device 220B is proximate to boundary 270A. In one or more embodiments, determining if the VR device is proximate to a boundary may include determining if VR device is at or within a distance to the boundary. If the VR device determines that the VR device is not proximate to the boundary, the method may proceed to 515, according to one or more embodiments. When the method proceed to 515, the wireless protocol with greater measurement precision may no longer be utilized, according to one or more embodiments. For example, WiGig may not longer be utilized in determining one or more positions of VR device 220.

If the VR device is proximate to the boundary, the VR device 220 may provide information to a user of the VR device, at 535. For example, VR device 220 may provide information to user 210. In one or more embodiments, the information may be conveyed to the user by performing one or more of vibrating, producing one or more sounds, and displaying one or more images and/or one or more videos to user 210. For example, one or more vibrations, one or more sounds, one or more images, and/or the one or more videos provided to user 210 may direct one or more movements of user 210 away from the boundary. For instance, the one or more images may include one or more VR images. In one or more embodiments, the method may proceed to 515, according to one or more embodiments. When the method proceed to 515, the wireless protocol with greater measurement precision may no longer be utilized, according to one or more embodiments. For example, WiGig may not longer be utilized in determining one or more positions of VR device 220.

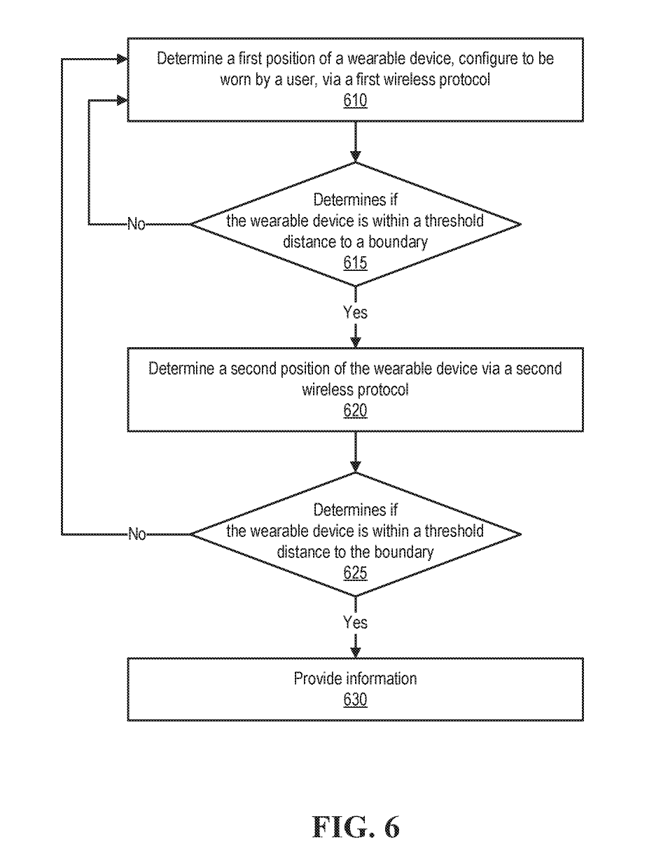

Turning now to FIG. 6, a method of operating a system that utilizes a wearable device is illustrated, according to one or more embodiments. At 610, a first position of a wearable device, configured to be worn by a user, may be determined via a first wireless protocol. In one example, the wearable device may include VR device 220, and a position of VR device 220 may be determined. In one instance, the first wireless protocol may include IEEE 802.11mc. In another instance, the first wireless protocol may include a Wi-Fi protocol. In a second example, the wearable device may determine the first position via the first wireless protocol. In another example, IHS 110 may determine the first position via the first wireless protocol.

At 615, it may be determined, based at least on the first position, if the wearable device is within a threshold distance of a boundary. In one example, IHS 110 may determine, based at least on the first position, if the wearable device is within the threshold distance of the boundary. In one example, the wearable device may determine, based at least on the first position, if the wearable device is within the threshold distance of the boundary. In another example, the wearable device may determine, based at least on the first position, if the wearable device is within the threshold distance of the boundary. For instance, the wearable device may include VR device 220. In one or more embodiments, the boundary may include an interior boundary. For example, the boundary may include interior boundary 240. For instance, the threshold distance may include distance 260. In one or more embodiments, the boundary may be a boundary of an activity area. For example, the boundary may include boundary 230. In one instance, the threshold distance may include one of distances 250A-250D. In another instance, the threshold distance may include distance 250B plus distance 260. In one or more embodiments, the boundary may be a boundary of a VR device. In one example, the boundary may include boundary 270A. In another example, the boundary may include boundary 270B.

If the wearable device is not within the threshold distance of the boundary, the method may proceed to 610. In one or more embodiments, utilization of the second wireless protocol to determine one or more positions of the wearable device may be ceased in response to determining that the wearable device is not within the threshold distance of the boundary. If the wearable device is within the threshold distance of the boundary, a second position of the wearable device may be determined via a second wireless protocol, at 620.

In one or more embodiments, the second wireless protocol may be operable to provide greater measurement precision than the first wireless protocol. For example, the second wireless protocol may include a WiGig protocol. For instance, the second wireless protocol may include IEEE 802.11ad. In one or more embodiments, determining the second position of the wearable device via the second wireless protocol may be performed in response to determining, based at least on the first position, that the wearable device is within the threshold distance of the boundary. In one or more embodiments, determining the second position of the wearable device via the second wireless protocol may include determining an angular position of the wearable device. For example, the angular position of the wearable device may be relative to IHS 110.

At 625, it may be determined if the wearable device is within a threshold distance to the boundary. In one or more embodiments, determining if the wearable device is within the threshold distance to the boundary may include utilizing the second position. For example, utilizing the second position may provide a better determination if the wearable device is within the threshold distance to the boundary. If the wearable device is not within the threshold distance to the boundary, the method may proceed to 610, according to one or more embodiments. When the method proceed to 610, the second wireless protocol may no longer be utilized in determining one or more positions of the wearable device, according to one or more embodiments. For example, WiGig may not longer be utilized in determining one or more positions of the wearable device. For instance, WiGig may not longer be utilized in determining one or more positions of VR device 220.

If the wearable device is within a threshold distance to the boundary, information may be provided. In one example, IHS 110 may provide information to VR device 220. In one or more embodiments, the information may include data and/or instructions that may cause VR device 220 to perform one or more of vibrating, producing one or more sounds, and displaying one or more images and/or one or more videos to user 210. For example, one or more vibrations, one or more sounds, one or more images, and/or one or more videos provided to user 210 may direct one or more movements of user 210 away from the boundary. For instance, the one or more images may include one or more VR images. In another example, VR device 220 may provide information to user 210. In one or more embodiments, the information may be conveyed to the user by performing one or more of vibrating, producing one or more sounds, and displaying one or more images and/or one or more videos to user 210. In one example, one or more vibrations, one or more sounds, one or more images, and/or one or more videos provided to user 210 may direct one or more movements of user 210 away from the boundary. For instance, the one or more images may include one or more VR images. In another example, the information may be conveyed to the user by providing one or more alerts to user 210.

In one or more embodiments, one or more of the method and/or process elements and/or one or more portions of a method and/or processor elements may be performed in varying orders, may be repeated, or may be omitted. Furthermore, additional, supplementary, and/or duplicated method and/or process elements may be implemented, instantiated, and/or performed as desired, according to one or more embodiments. Moreover, one or more of system elements may be omitted and/or additional system elements may be added as desired, according to one or more embodiments.

In one or more embodiments, a memory medium may be and/or may include an article of manufacture. For example, the article of manufacture may include and/or may be a software product and/or a program product. For instance, the memory medium may be coded and/or encoded with processor-executable instructions in accordance with one or more flowcharts, systems, methods, and/or processes described herein to produce the article of manufacture.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. An information handling system, comprising:
a processor; and
a memory medium, communicatively coupled to the processor, that includes instructions executable by the processor to cause the information handling system to:
determine a first position of a wearable device, configured to be worn by a user, via a first wireless protocol;
determine, based at least on the first position, that the wearable device is within a threshold distance of a boundary; and
in response to determining, based at least on the first position, that the wearable device is within the threshold distance of the boundary, determine a second position of the wearable device via a second wireless protocol, different from the first wireless protocol, that is operable to provide greater measurement precision than the first wireless protocol.

2. The information handling system of claim 1, wherein the wearable device includes a head mounted display.

3. The information handling system of claim 1, wherein the memory medium further includes instructions executable by the processor to cause the information handling system to further:
determine, based at least on the second position, that the wearable device is within the threshold distance of the boundary;
in response to determining, based at least on the second position, that the wearable device is within the threshold distance of the boundary, provide at least one virtual reality image to the head mounted display to direct one or more movements of the user away from the boundary.

4. The information handling system of claim 1, wherein the memory medium further includes instructions executable by the processor to cause the information handling system to further:
determine, based at least on the second position, that the wearable device is within the threshold distance of the boundary;
in response to determining, based at least on the second position, that the wearable device is within the threshold distance of the boundary, provide an alert to the wearable device.

5. The information handling system of claim 1, wherein the memory medium further includes instructions executable by the processor to cause the information handling system to further:
determine, based at least on the second position, that the wearable device is not within the threshold distance of the boundary; and
in response to determining, based at least on the second position, that the wearable device is not within the threshold distance of the boundary, cease utilization of the second wireless protocol to determine one or more positions of the wearable device.

6. The information handling system of claim 1,
wherein the first wireless protocol includes a Wi-Fi protocol; and
wherein the second protocol includes a WiGig protocol.

7. The information handling system of claim 1, wherein, to determine the second position of the wearable device via the second wireless protocol, different from the first wireless protocol, that is operable to provide greater measurement precision than the first wireless protocol, the memory medium further includes instructions executable by the processor to cause the information handling system to further determine an angular position.

8. A method, comprising:
determining a first position of a wearable device, configured to be worn by a user, via a first wireless protocol;
determining, based at least on the first position, that the wearable device is within a threshold distance of a boundary; and
in response to the determining, based at least on the first position, that the wearable device is within the threshold distance of the boundary, determining a second position of the wearable device via a second wireless protocol, different from the first wireless protocol, that is operable to provide greater measurement precision than the first wireless protocol.

9. The method of claim 8, wherein the wearable device includes a head mounted display.

10. The method of claim 8, further comprising:
determining, based at least on the second position, that the wearable device is within the threshold distance of the boundary;
in response to the determining, based at least on the second position, that the wearable device is within the threshold distance of the boundary, providing at least one virtual reality image to the head mounted display to direct one or more movements of the user away from the boundary.

11. The method of claim 8, further comprising:
determining, based at least on the second position, that the wearable device is within the threshold distance of the boundary;
in response to the determining, based at least on the second position, that the wearable device is within the threshold distance of the boundary, providing an alert to the wearable device.

12. The method of claim 8, further comprising:
determining, based at least on the second position, that the wearable device is not within the threshold distance of the boundary; and
in response to the determining, based at least on the second position, that the wearable device is not within the threshold distance of the boundary, ceasing utilization of the second wireless protocol to determine one or more positions of the wearable device.

13. The method of claim 8,
wherein the first wireless protocol includes a Wi-Fi protocol; and
wherein the second protocol includes a WiGig protocol.

14. The method of claim 8, wherein the determining the second position of the wearable device via the second wireless protocol, different from the first wireless protocol, that is operable to provide greater measurement precision than the first wireless protocol includes determining an angular position.

15. A computer-readable non-transitory memory medium that includes instructions that, when executed by a processor of an information handling system, cause the information handling system to:
determine a first position of a wearable device, configured to be worn by a user, via a first wireless protocol;
determine, based at least on the first position, that the wearable device is within a threshold distance of a boundary; and
in response to determining, based at least on the first position, that the wearable device is within the threshold distance of the boundary, determine a second position of the wearable device via a second wireless protocol, different from the first wireless protocol, that is operable to provide greater measurement precision than the first wireless protocol.

16. The computer-readable non-transitory memory medium of claim 15, wherein the wearable device includes a head mounted display.

17. The computer-readable non-transitory memory medium of claim 15, wherein the computer-readable non-transitory memory medium further includes instructions executable by the processor to cause the information handling system to further:
determine, based at least on the second position, that the wearable device is within the threshold distance of the boundary;
in response to determining, based at least on the second position, that the wearable device is within the threshold distance of the boundary, provide at least one virtual reality image to the head mounted display to direct one or more movements of the user away from the boundary.

18. The computer-readable non-transitory memory medium of claim 15, wherein the computer-readable non-transitory memory medium further includes instructions executable by the processor to cause the information handling system to further:
determine, based at least on the second position, that the wearable device is within the threshold distance of the boundary;
in response to determining, based at least on the second position, that the wearable device is within the threshold distance of the boundary, provide an alert to the wearable device.

19. The computer-readable non-transitory memory medium of claim 15, wherein the computer-readable non-transitory memory medium further includes instructions executable by the processor to cause the information handling system to further:
determine, based at least on the second position, that the wearable device is not within the threshold distance of the boundary; and
in response to determining, based at least on the second position, that the wearable device is not within the threshold distance of the boundary, cease utilization of the second wireless protocol to determine one or more positions of the wearable device.

20. The computer-readable non-transitory memory medium of claim 15,
wherein the first wireless protocol includes a Wi-Fi protocol; and
wherein the second protocol includes a WiGig protocol.
